(19) United States
(12) Patent Application Publication
(10) Pub. No.: US 2010/0031174 A1
(43) Pub. Date: Feb. 4, 2010

(54) MOBILE TERMINAL AND METHOD FOR DISPLAYING INFORMATION USING THE SAME

(75) Inventor: In Hwan Kim, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/402,846

(22) Filed: Mar. 12, 2009

(30) Foreign Application Priority Data
Jul. 31, 2008 (KR) 10-2008-0074914

(51) Int. Cl. G06F 3/048

(52) U.S. Cl. 715/764; 715/863

(57) ABSTRACT

A wireless communication terminal is provided for use in interactive communication with a base station (BS) to allow exchange of displayed image related information. A display is configured to display a broadcast image from the BS. The broadcast image is associated with a time stamp recognized by the BS. The broadcast image includes an object displayed on the display. An input module is configured to recognize a selected position on the display associated with the object. A controller is in communication with the display and the input module. The controller is configured to associate the selected position with the object, to provide coordinate data corresponding to the selected position, to provide to the BS a time reference in relation to the time stamp when the selected position is recognized, to receive from the BS object information related to the object, and to display the object information received from the BS.

### CROSS-REFERENCE TO RELATED APPLICATIONS

Pursuant to 35 U.S.C. § 119(a), this application claims the benefit of earlier filing date and right of priority to Korean Application No. 10-2008-0074914, filed on Jul. 31, 2008, the contents of which are incorporated by reference herein in its entirety.

### FIELD OF THE INVENTION

The invention relates generally to a mobile terminal and a method for displaying information in the mobile terminal, and particularly, to a mobile terminal which displays information relevant to user's selected input on a screen, and a method for displaying the information.

### DESCRIPTION OF THE RELATED ART

Generally, a mobile terminal is a portable gadget having one or more functions of voice and image communication, inputting/outputting information, and storing data. The mobile terminal has increasingly served as a multimedia player providing complicated functions such as, for example, taking a picture or a moving picture, reproducing a music file or a moving picture file, playing a game, and receiving a broadcast.

Recently, an interactive broadcasting service function has been provided in mobile terminals to provide selected contents at a selected time to a viewer. By using the interactive broadcasting service function, the viewer can directly participate in a quiz show, take part in a survey, cast a vote, enjoy a home shopping service, or use a home banking service or an e-mail service.

FIG. 11 is a schematic view illustrating a screen 1000 of a conventional mobile terminal in which the interactive broadcasting service function is displayed on the screen 1000. While a broadcast program is reproduced through a screen 1000 of the mobile terminal, if the interactive broadcasting service function 1010 of purchasing goods is contained in the broadcast program, an icon 1020 is displayed on the screen informing a user that the interactive broadcasting service function 1010 is available. The user can select the icon 1020 and receive information on the goods reproduced in the broadcast program.

However, there is a problem that information can be restrictively provided through the mobile terminal only when the interactive broadcasting service function is contained in the broadcast program.

In addition, there is a problem that a method of directly inputting necessary information by the user is very restrictive.

Further, there is another problem that, since information provided through the mobile terminal by a service provider is commonly provided to all the users, it is impossible to provide information requested by a specific user only.

### SUMMARY OF THE INVENTION

A mobile terminal is provided including an input display unit, a communication unit, and a controller. The input display unit is configured to receive pointing inputs from a user during a broadcast. The pointing inputs include a user instruction pointing input corresponding to a user instruction. The communication unit is configured to form a communication channel with a network. The controller is configured to transmit time information on when the user provides the user instruction pointing input, to transmit coordinate information on a position of the user instruction pointing input to the network, to receive information on an object corresponding to the user instruction pointing input from the network, and to provide the information to the user.

In one embodiment, the controller is configured to receive coordinate information from the input display unit. The coordinate information includes positions on the input display unit corresponding to the pointing inputs.

In one embodiment, the controller is configured to provide an activation icon on the input display unit for allowing or disallowing the user instruction pointing input.

In one embodiment, the controller is configured to allow the user instruction pointing input when the user provides a pointing input to the activation icon displayed on the input display unit while the user instruction pointing input is disallowed. In addition, the controller is configured to disallow the user instruction pointing input when the user provides a pointing input to the activation icon displayed on the input display unit while the user instruction pointing input is allowed.

In one embodiment, the controller receives the information in the form of a character message from the network.

In one embodiment, the character message is a short-message-service message or a multimedia-messaging-service message.

In one embodiment, the controller receives from the network information having at least one of the forms of a text, an image, an icon, a moving image and an animation and then displays the information on the input display unit.

In one embodiment, the information on the object is at least one of personal information, goods information, or background information contained in a broadcast.

In one embodiment, the mobile station further includes a memory for storing available interactive functions.

In one embodiment, the controller is configured to transmit to the network a reproduction time and information on a user-selected interactive function of the available interactive functions. The reproduction time is a time period from a start of the broadcast to a time at which the user provides the user instruction pointing input.

In one embodiment, the controller is configured to display a function icon on the input display unit for allowing a user to request display of the available interactive functions.

In one embodiment, the controller is configured to display detailed information on the available interactive functions when the user provides a pointing input on the function icon displayed on the input display unit.

In one embodiment, the controller is configured to display detailed information on the available interactive functions when the user provides the user instruction pointing input.

In one embodiment, the controller is configured to display the received information on the object while the broadcast is stopped.

In one embodiment, the controller is configured to display semitransparently the received information on the object while the broadcast is playing.

In an exemplary embodiment of the present invention, a method for displaying information in a mobile terminal is provided. Pointing inputs are received from a user during a broadcast. The pointing inputs include a user instruction pointing input corresponding to a user instruction. Time information is transmitted to a network when a user provides the user instruction pointing input. Coordinate information is transmitted to the network on a position of the user instruction pointing input. Information is received on an object corresponding to the user instruction pointing input from the network. The received information is provided to the user.

In one embodiment, the information is received and provided to the user such that the information includes at least one of text, an image, an icon, a moving image, or an animation.

In one embodiment, a function icon is displayed during the broadcast. Detailed information is displayed on available interactive functions when the user provides a pointing input corresponding to the function icon. A selected interactive function is received when the user points to and selects one of the available interactive functions. The user instruction pointing input is received when the user points to an object in the broadcast.

In one embodiment, the user instruction pointing input is received when the user points to an object in the broadcast while the user instruction pointing input is allowed. Detailed information is displayed on the available interactive functions corresponding to the user instruction pointing input. A selected interactive function is received when the user points to and selects one of the available interactive functions.

In an exemplary embodiment of the present invention, a wireless communication terminal for use in an interactive communication with a base station to allow exchange of displayed image related information is provided. The wireless communication terminal includes a display, an input module, and a controller. The display is configured to display a broadcast image from the base station. The broadcast image is associated with a time stamp recognized by the base station. The broadcast image includes an object displayed on the display. The input module is configured to recognize a selected position on the display associated with the object. The controller is in communication with the display and the input module. The controller is configured to associate the selected position with the object, to provide coordinate data corresponding to the selected position, to provide to the base station a time reference in relation to the time stamp when the selected position is recognized, to receive from the base station object information related to the object, and to display the object information received from the base station.

In one embodiment, the input module includes a touch screen for sensing a user touch and for recognizing the selected position.

In one embodiment, the object information includes at least one of price, manufacturer, or production description.

In one embodiment, the controller is configured to receive the object information through one of a text message, a multimedia message, or electronic e-mail.

### BRIEF DESCRIPTION OF THE DRAWINGS

FIG. 1 is a block diagram illustrating a mobile terminal according to an embodiment of the present invention.

FIG. 2 is a front perspective view illustrating the mobile terminal according to an embodiment of the present invention.

FIG. 3 is a rear perspective view illustrating the mobile terminal according to an embodiment of the present invention.

FIG. 4 is a schematic view illustrating a structure of a touch screen according to an embodiment of the present invention.

FIG. 5 is a schematic view illustrating a principle of detecting a proximity distance of an object using the touch screen of FIG. 4.

FIG. 6 is a schematic view illustrating a principle of detecting a position of an object using the touch screen of FIG. 4.

FIG. 7 is a block diagram illustrating a mobile terminal which can provide information in response to a user instruction according to an embodiment of the present invention.

FIG. 8 is a schematic view illustrating a transmitting and receiving process between a mobile terminal and a network.

FIG. 9 is a schematic view illustrating a display state of a display unit through which a user inputs a user instruction by selecting a kind of interactive function and receives information.

FIG. 10a and FIG. 10b are schematic views illustrating an information providing process using a mobile terminal which includes selecting of the interactive function according to an embodiment of the present invention.

FIG. 11 is a diagram illustrating a screen of a mobile terminal which can provide information through a conventional interactive function.

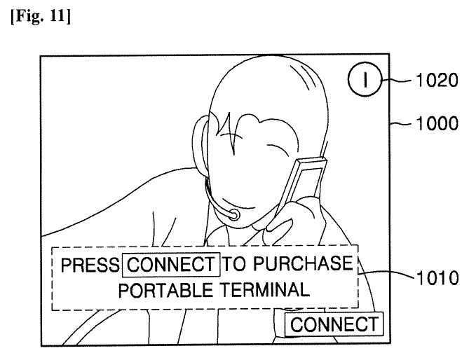

### DETAILED DESCRIPTION

A touch screen is a convenient pointing device for a mobile terminal. A pointing device such as a track ball may be also used with a mobile terminal. A ‘touch’ operation in the touch screen is a ‘pointing’ operation in a typical pointing device.

The mobile terminal is wirelessly connected with a wireless communication network of a communication service provider. The mobile terminal can be connected through the wireless communication network to an Internet service provider server that provides various Internet services like a blog.

The mobile terminal described in this application includes a cellular phone, a smart phone, a notebook computer, a digital multimedia broadcasting (DMB) terminal, a personal digital assistant (PDA), a personal multimedia player (PMP), and a navigation system.

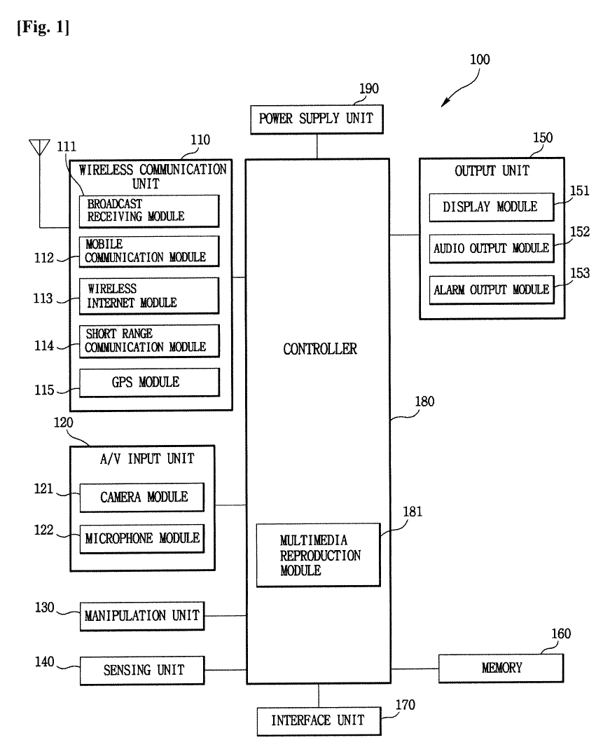

FIG. 1 is a block diagram illustrating a mobile terminal according to an embodiment of the present invention. The mobile terminal 100 may include a wireless communication unit 110, an A/V (Audio/Video) input unit 120, a manipulation unit 130, a sensing unit 140, an output unit 150, a memory 160, an interface unit 170, a controller 180 and a power supply unit 190. Two or more of the aforementioned elements may be combined into one element, or one element may be divided into two or more elements.

The wireless communication unit 110 may include a broadcast receiving module 111, a mobile communication module 112, a wireless Internet module 113, a short range communication module 114, and a global positioning system (GPS) module 115.

The broadcast receiving module 111 receives a broadcast signal and/or information relevant to a broadcast from an external broadcast management server through a broadcast channel. The broadcast channel may include a satellite broadcast channel and a terrestrial broadcast channel. The broadcast management server may be a server that generates and transmits a broadcast signal and/or information relevant to a broadcast, or a server that receives an already generated broadcast signal and/or information relevant to a broadcast and then transmits the signal/information to a terminal. The information relevant to a broadcast may be information including a broadcast channel, a broadcast program, or a broadcast service provider. The broadcast signal may include a TV broadcast signal, a radio broadcast signal, a data broadcast signal, or a broadcast signal in which the data broadcast signal is combined with the TV broadcast signal or the radio broadcast signal.

The information relevant to a broadcast can be provided through a mobile communication network. In this case, the information relevant to a broadcast can be received through the mobile communication module 112.

The information relevant to a broadcast can be provided in various types, for example, electronic program guide (EPG) of DMB or electronic service guide (ESG) of digital video broadcasting-handheld (DVB-H).

The broadcast receiving module 111 can receive the broadcast signal using various broadcasting systems. Particularly, the broadcast receiving module 111 can receive a digital broadcast signal using a digital broadcasting system such as DMB-T (Digital Multimedia Broadcasting-Terrestrial), DMB-S (Digital Multimedia Broadcasting-Satellite), MediaFLO™ (Media Forward Link Only), DVB-H (Digital Video Broadcast-Handheld), and ISDB-T (Integrated Services Digital Broadcast-Terrestrial). The broadcast receiving module 111 can be applied to all broadcasting systems that provide a broadcast signal, as well as the digital broadcasting systems.

A broadcast signal and/or information relevant to a broadcast received through the broadcast receiving module 111 can be stored in the memory 160.

The mobile communication module 112 receives and transmits a wireless signal from/to at least one of a base station, an external terminal, or a server on a mobile communication network. The wireless signal can include an audio signal, an image communication call signal, and various data for receiving and transmitting a short message service (SMS) message or multimedia messaging service (MMS) message (i.e., character/multimedia message).

The wireless Internet module 113 is a module for wireless Internet connection. The wireless Internet module 113 can be provided inside or outside the mobile terminal.

The short range communication module 114 is a module for local area communication using a local area communication technology such as Bluetooth®, RFID (Radio Frequency Identification), IrDA (Infrared Data Association), UWB (Ultra Wideband), and ZigBee®.

The GPS module 115 receives navigation information from a plurality of artificial satellites.

The A/V input unit 120 is for inputting an audio signal or a video signal, and can include a camera module 121 and a microphone module 122. The camera module 121 processes an image frame of a still image and a moving image obtained from an image sensor in an image communication mode or a picture taking mode. The processed image frame can be displayed on a display module 151.

The image frame processed in the camera module 121 can be stored in the memory 160 or transmitted externally through the wireless communication unit 110. Two or more camera modules 121 may be provided according to a construction type of the mobile terminal.

The microphone module 122 receives an external audio signal through a microphone in a communication mode, a record mode, or a voice recognition mode and processes the audio signal into electrical audio data. In the communication mode, the processed audio data can be converted, transmitted to a mobile communication base station through the mobile communication module 112, and then outputted. The microphone module 122 can have various noise removing algorithms for removing noise generated while receiving an external audio signal.

The manipulation unit 130 generates key-input data that is inputted by a user in order to control an operation of the terminal. The manipulation unit 130 includes a key pad, a dome switch, a touch pad (static pressure type/electrostatic type), a jog wheel, or a jog switch. Particularly, if the touch pad is layered on to a display module 151, the touch pad/display module 151 may be called a touch screen.

The sensing unit 140 senses a present state of the mobile terminal 100, such as whether the mobile terminal 100 is opened or closed, a position of the mobile terminal 100, and whether the user is in contact with the mobile terminal 100. The sensing unit 140 then generates a sensing signal for controlling an operation of the mobile terminal 100. For example, if the mobile terminal 100 is a slide type mobile terminal, the sensing unit 140 can sense whether the slide type mobile terminal is opened or closed. Further, the sensing unit 140 can sense whether the power supply unit 190 supplies power and whether the interface unit 170 is connected with an external unit.

The interface unit 170 provides an interface between the mobile terminal 100 and all external units connected with the mobile terminal 100. For example, the interface unit 170 may include a wire/wireless headset port, an external charger port, a wire/wireless data port, a card socket (e.g., a memory card, a SIM/UIM card), an audio I/O (Input/Output) terminal, a video I/O (Input/Output) terminal, and/or an earphone port. The interface unit 170 receives data or power from the external units and transmits the data or provides the power to each element in the mobile terminal 100. In addition, the interface unit 170 transmits data from the mobile terminal 100 to the external units.

The output unit 150 is for outputting an audio signal, a video signal, or an alarm signal. The output unit 150 can include a display module 151, an audio output module 152, and an alarm output module 153.

The display module 151 displays information processed in the mobile terminal 100. For example, when the mobile terminal 100 is in the communication mode, the display module 151 displays a user interface (UI) or a graphic user interface (GUI) related to the communication. When the mobile terminal 100 is in the image communication mode or the picture taking mode, the display module 151 displays a taken and/or received image, a UI, or a GUI.

When the touch pad and the display module 151 are in a layered structure form as a touch screen, the display module 151 can function as an input unit as well as an output unit. The display module 151 can include at least one of a liquid crystal display, a thin film transistor-liquid crystal display, an organic light-emitting diode, a flexible display, or a 3D display. Two or more display modules 151 may be provided according to a construction type of the mobile terminal 100. For example, the mobile terminal 100 may have an external display module and an internal display module at the same time.

The audio output module 152 outputs audio data stored in the memory 160 or received from the wireless communication unit 110 in a call signal receiving mode, a communication mode, a recording mode, a voice recognition mode, or a broadcast signal receiving mode. Further, the audio output module 152 outputs an audio signal (e.g., a call signal receipt melody, a message receipt melody) related to functions performed in the mobile terminal 100, and can include a speaker and a buzzer.

The alarm output module 153 outputs a signal for informing a user of an event in the mobile terminal 100. For example, the event generated in the mobile terminal 100 includes a call signal receipt requesting a phone call, a message receipt, a key signal input, and an alarm for informing a user of a predetermined time. The alarm output module 153 can output other types of signals, different from the audio signal or the video signal, for informing of an event in the mobile terminal 100. For example, the signal may be a vibration. When receiving a call signal or a message, the alarm output module 153 can output the vibration to inform of the event. When a key signal is inputted, the output module 153 can output the vibration as a feedback signal responsive to the inputting of the key signal. The user can recognize the event through the output of the vibration. The signal for informing the generation of an event can be outputted through the display module 151 or the audio output module 152.

The memory 160 can store a program for processing and controlling the controller 180, and can also function to temporarily store input/output data such as a phonebook, a message, a still image, and a moving image.

The memory 160 can include at least one type of storage medium selected from a flash memory, a hard disk memory, a multimedia card micro memory, a card memory (e.g., SD or XD memory), RAM, or ROM. Further, the mobile terminal 100 can manage a web storage for storing data that is stored in the memory 160 on the Internet.

The controller 180 generally controls operations of the mobile terminal 100. For example, the controller 180 controls and processes the voice communication, the data communication, and the image communication. The controller 180 can have a multimedia reproduction module 181 for reproducing multimedia data. The multimedia reproduction module 181 can be provided in the form of hardware in the controller 180, or provided in the form of software separate from the controller 180.

The controller 180 can recognize a proximity touch motion or a direct touch motion of an object such as a user's finger and change a size or a scope of an image displayed on the touch screen. To this end, the controller 180 can display a scroll bar or a mini-map on the touch screen to control the size and scope of an image displayed on the touch screen.

The power supply unit 190 receives power from an external power source or an internal power source through control of the controller 180 and then supplies the power to each element.

A slide type mobile terminal will be described among various types of mobile terminals, which also include bar type and a slide type mobile terminals. The present invention is not limited to the slide type mobile terminal, as embodiments also apply to the above-mentioned additional types of mobile terminals.

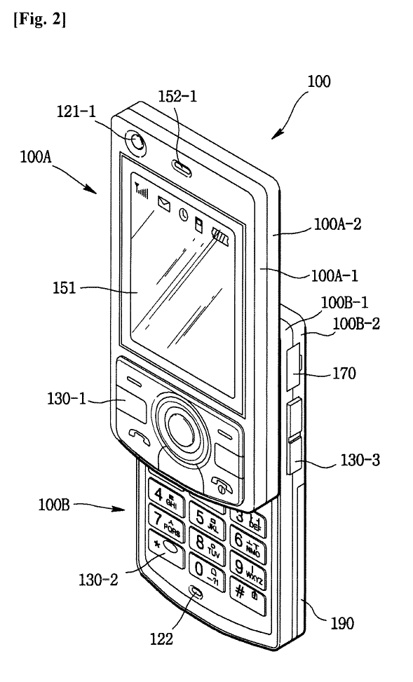

FIG. 2 is a front perspective view illustrating the mobile terminal according to an embodiment of the present invention. The mobile terminal 100 of the present invention includes a first body 100A and a second body 100B disposed adjacent to the first body 100A for sliding in at least one direction along the first body 100A.

When the first and second bodies 100A and 100B are overlapped with each other they are in a closed configuration. When at least a part of the second body 100B is exposed by the first body 100A they are in an open configuration.

In the closed configuration, the mobile terminal 100 is mainly operated in a standby mode, but the standby mode can be canceled by a user. In the open configuration, the mobile terminal 100 is mainly operated in a communication mode, but the communication mode can be converted into the standby mode by the user or after a lapse of predetermined time.

A case (i.e., casing, housing, or cover) forming an external shape of the first body 100A includes a first front case 100A-1 and a first rear case 100A-2. Various electronic parts are installed in a space defined by the first front case 100A-1 and the first rear case 100A-2. At least one middle case may be additionally disposed between the first front case 100A-1 and the first rear case 100A-2.

The cases can be formed by injection molding of synthetic resin, or formed of a metallic material such as stainless steel or titanium (Ti).

A display module 151, a first audio output module 152-1, a first camera module 121-1 or a first manipulation unit 130-1 can be disposed at the first body 100A, specifically, the first front case 100A-1.

The display module 151 may be a liquid crystal display (LCD) or an organic light emitting diode (OLED) display for visually displaying information.

A touch pad may be layered on the display module 151, and thus the display module 151 can be operated as a touch screen so that information can be inputted by a touch motion of a user.

The first audio output module 152-1 can be provided in the form of a receiver or a speaker. The first camera module 121-1 can be formed so that the user can take an image or a moving image.

Like in the first body 100A, a case forming an external shape of the second body 100B includes a second front case 10B-1 and a second rear case 100B-2.

A second manipulation unit 130-2 can be disposed at a front face of the second body 100B, specifically, the second front case 100B-1.

A third manipulation unit 130-3, a microphone module 122, and an interface unit 170 can be disposed in at least one of the second front case 100B-1 and the second rear case 100B-2.

The first to third manipulation parts 130-1, 130-2 and 130-3 are part of the manipulation unit 130. The manipulation unit 130 can be operated in a tactile manner such that a tactile impression can be given to a user during an operation of the manipulation unit 130.

The manipulation unit 130 may be provided in the form of a dome switch or a touch pad in which instruction or information can be inputted by a push or touch operation of a user. Alternatively, the manipulation unit 130 may be provided in the form of a jog wheel or a jog switch with a rotatable key or in the form of a joystick.

The first manipulation unit 130-1 allows a user to input an instruction such as start, end, and scroll. The second manipulation unit 130-2 allows a user to input numbers, characters, and symbols. The third manipulation unit 130-3 can served as a hot-key for activating a special function of the mobile terminal.

The microphone module 122 can be provided to receive a voice of a user or other sounds.

The interface unit 170 serves as a passage through which the mobile terminal 100 can exchange data with external devices or receive power from external power sources. The interface unit 170 may be a wire/wireless earphone connection port, a wire/wireless local area communication port (e.g., an IrDA port, a Bluetooth® port, a wireless LAN port), or a power supply terminal for supplying power to the mobile terminal 100.

The interface unit 170 may be a card socket for receiving an external card such as a memory card for storing information, a subscriber identification module (SIM), or a user identity module (UIM).

The power supply unit 190 for supplying power to the mobile terminal 100 is disposed at the second rear case 100B-2. The power supply unit 190 may be a rechargeable battery which can be removably coupled to the mobile terminal 100.

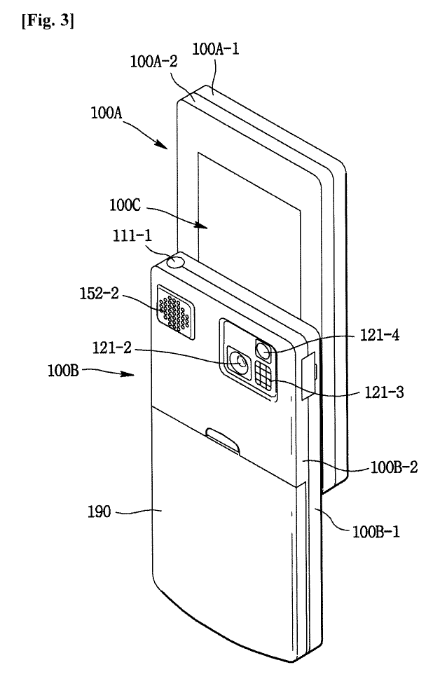

FIG. 3 is a rear perspective view of the mobile terminal of FIG. 2. A second camera module 121-2 can be additionally provided at a rear face of the second rear case 100B-2 of the second body 10B. The second camera module 121-2 has a picture-taking direction which is substantially opposed to the picture-taking direction of the first camera module 121-1 (referring to FIG. 1). In addition, the second camera module 121-2 can have a different pixel density from the first camera module 121-1.

For example, the first camera module 121-1 may have a low pixel density so as to take a picture of a user's face in an image communication mode and then smoothly transmit the taken image to a counterpart caller. However, when a user takes a picture of a general object, the taken picture is not typically transmitted immediately, and thus the second camera module 121-2 may have a higher pixel density.

A flash 121-3 and a mirror 121-4 can be additionally provided adjacent to the second camera module 121-2. When the second camera module 121-2 takes a picture of an object, the flash 121-3 provides light on the object. When a user wants to take his/her own picture using the second camera module 121-2, the user can look in the mirror 121-4 to properly align the camera module 121-2.

A second audio output module 152-2 can be additionally disposed at the second rear case 100B-2. The second audio output module 152-2 along with the first audio output module 152-1 (referring to FIG. 2) can provide a stereo function and can also can be used for communication in a speakerphone mode.

A broadcast signal receiving antenna 111-1 can be disposed at one side of the second rear case 100B-2. The broadcast signal receiving antenna 111-1 can be provided to be drawn out from the second body 100B.

One part of a slide module 100C for slidably coupling the first body 100A and the second body 100B is disposed at the first rear case 100A-2 of the first body 100A. The corresponding part of the slide module 100C is disposed at the second front case 10B-1 of the second body 100B so as not to be exposed to the outside, as shown in drawing.

In the above description, the second camera module 121-2 and other elements are disposed at the second body 100B, but embodiment of the present invention are not thus limited. For example, at least one or more elements among the broadcast signal receiving antenna 111-1, the second camera module 121-2, the flash 121-3, and the second audio output module 152-2 disposed at the second rear case 100B-2 may alternatively be disposed at the first body 100A, more specifically, at the first rear case 100A-2. In this case, the disposition provides an advantage because the elements disposed at the first rear case 100A-2 can be protected by the second body 100B in the closed configuration. Furthermore, the first camera module 121-1 may be formed to be rotatable such that a user may take a photograph in the picture-taking direction of the second camera module 121-2.

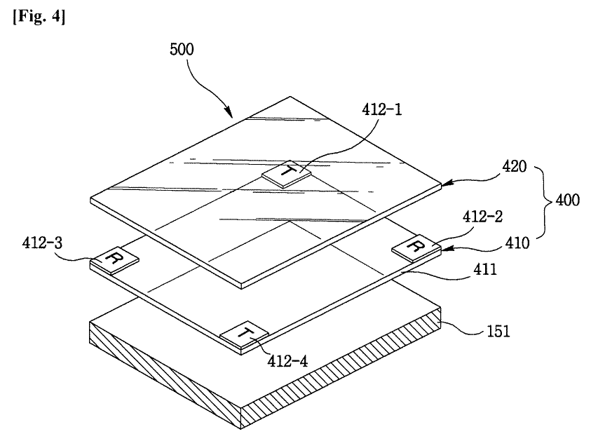

As shown in FIG. 4, a touch pad 400 is layered on the display module 151, thereby forming a touch screen 500. The touch pad 400 includes a tetragonal conductive film 411 formed of a transparent conductive material such as indium tin oxide (ITO) and metal electrodes 412-1 to 412-4 that are located at each corner portion of the conductive film 411. A passivation film 420 can be provided on the conductive film 411.

The touch pad 400 is a capacitive sensing type position detecting device in which electric field lines are formed between transmitter metal electrodes (T) 412-1 and 412-4 and receiver metal electrodes (R) 412-2 and 412-3 by an AC voltage applied to the transmitter metal electrodes (T) 412-1 and 412-4. The electric field lines are extended to an outside of the touch pad 400 through the passivation film 420. Therefore, if an object such as a user's finger approaches or directly touches the touch pad 400, a part of the electric field lines are cut off and thus intensity and phase of current flowing to the receiver metal electrodes (R) 412-2 and 412-3 are changed. Because a human body has a capacitance of a few pF with respect to the ground, if a user's finger approaches or directly touches the touch pad 400, the electric field lines formed on the touch pad 400 are distorted.

Processors provided in the mobile terminal 100 can detect a proximity distance of the object and a position touched by the object using the change of current at the receiver metal electrodes (R) 412-2 and 412-3 due to a touch motion of the object. The object includes all physical solids which can distort the electric field lines formed on the touch pad 400 such that the mobile terminal 100 can recognize a touch input.

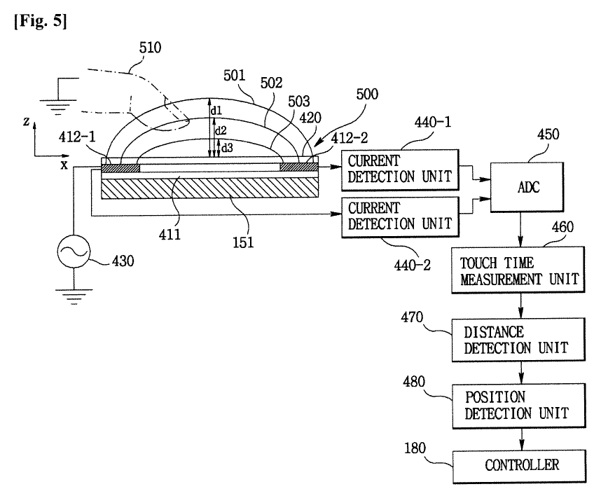

FIG. 5 is a schematic view illustrating a principle of detecting a proximity distance of an object using the touch screen of FIG. 4. As shown in FIG. 5, the electric field lines 501, 502, and 503 are formed between the transmitter metal electrode 412-1 and the receiver metal electrode 412-2 by applying an AC voltage 430 to the transmitter metal electrode 412-1 among the metal electrodes 412-1 to 412-4 formed on the transparent conductive film 411. The electric field lines 501, 502, 503 are formed to be extended in a vertical direction (i.e., z-direction) of the touch screen 500.

A density of the electric field lines 501, 502, 503 cut off by the user's finger 510 is changed corresponding to the proximity distance between the user's finger 510 and the touch screen 500. In other words, as the user's finger 510 approaches the touch screen 500, an influence exerted on the electric field lines 501, 502, 503 by the user's finger 510 is increased.

The influence exerted on the electric field lines 501, 502, 503 by the user's finger 510 changes the current applied to current detection units 440-1, 440-2 connected to each metal electrode 412-1, 412-2, respectively. The current detection units 440-1, 440-2 detect the change of the current and transmit the detected change in current to an analog-digital converter 450. The analog-digital converter 450 then converts an analog value of the current change into a digital value and transmits the digital value to a touch time measurement unit 460.

The touch time measurement unit 460 measures a time that the finger 510 stays within an effective distance (i.e., ‘d1’ in FIG. 5), in which the touch screen 500 can recognize approaching of the finger 510, using information on the current change provided from the analog-digital converter 450. Therefore, if the finger 510 stays for a predetermined time period (e.g., 1 second) within the effective distance (i.e., ‘d1’ in FIG. 5), the touch time measurement unit 460 perceives that the finger 510 has performed a proximity touch motion or a direct touch motion. On the other hand, if the finger 510 does not stay for a predetermined time period (e.g., 1 second) within the effective distance (i.e., ‘d1’ in FIG. 5), the touch time measurement unit 460 perceives that the finger 510 has not performed a proximity touch motion or a direct touch motion.

As described above, if the touch time measurement unit 460 perceives a touch input (i.e., proximity touch motion or direct touch motion) of the finger 510 with respect to the touch screen 500, the touch time measurement unit 460 provides information on generation of the touch input and the current change to a distance detection unit 470.

The distance detection unit 470 calculates a distance between the finger 510 and the touch screen 500, that is, a distance that the finger 510 is spaced apart from the touch screen 500 in the vertical direction (i.e., z-direction) using information on the current change.

Specifically, if the finger 510 is located at a position that is nearer than a distance d1 (e.g., 30 mm) in the vertical direction (i.e., z-direction) of the touch pad 400 but farther than a distance d 2 (e.g., 20 mm) (i.e., located between d1 and d2), the distance detection unit 470 determines that the finger 510 is located within the effective distance in which the touch screen 500 starts to detect the touch motion of an external object, and then provides a function corresponding to the proximity touch motion. The proximity touch motion is a state in which an object, such as a user's finger, is located within the effective distance of the touch screen 500 in order to input a user instruction. The proximity touch motion, in which the object does not directly contact with the touch screen 500, is discriminated from the direct touch motion in which the object directly contacts the touch screen 500.

If the finger 510 is located at a position that is nearer than the distance d2 (e.g., 20 mm) in the vertical direction (i.e., z-direction) of the touch screen 500 but farther than a distance d 3 (e.g., 10 mm) (i.e., located between d2 and d3), the distance detection unit 470 determines that the finger 510 is in close proximity to the touch screen 500.

If the finger 510 is located at a position that is nearer than the distance d3 (e.g., 10 mm) in the vertical direction (i.e., z-direction) of the touch screen 500 (i.e., located within d3), or the finger 510 directly contacts a surface of the touch screen 500, the distance detection unit 470 determines that the finger 510 directly contacts the touch screen 500 within an error range.

In FIG. 5, the touch motion of the finger 510 is described such that there are three states of distance between the finger 510 and the touch screen 500. However, embodiments of the present invention are not thus limited, as therefore four or more states of distance between the finger 510 and the touch screen 500 may be utilized.

From the information on the current change, a position detection unit 480 calculates a position on the touch screen 500 designated by the finger 510. Specifically, the position detection unit 480 determines horizontal coordinates in x and y-directions on the touch screen 500. The y-direction extends along a surface of the touch screen 500 and is perpendicular to the x and z-directions in FIG. 5.

The vertical distance between the finger 510 and the touch screen 500 and the horizontal coordinates of the finger 510 located on the touch pad 400, as described above, are provided to a controller 180. The controller 180 determines the user instruction using the vertical distance and the horizontal coordinates, performs a control operation corresponding to the user instruction, and also provides a desired GUI on the display module 151.

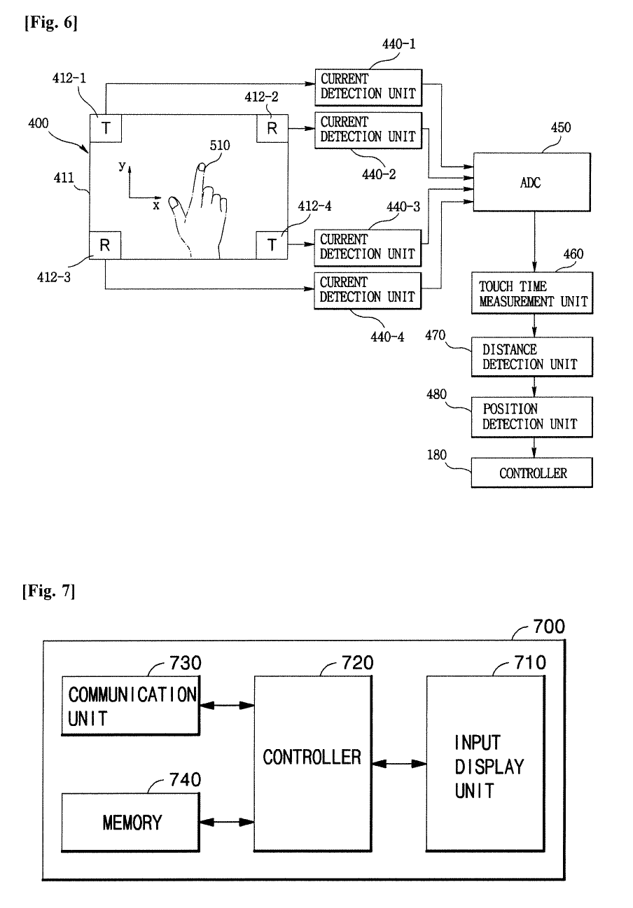

FIG. 6 is a schematic view illustrating a principle of detecting a position of an input medium using the touch screen of FIG. 4. As shown in FIG. 6, if an AC voltage is applied to the transmitter metal electrodes (T) 412-1 and 412-4 of the touch pad 400, the electric field lines are formed between the transmitter metal electrodes (T) 412-1 and 412-4 and the receiver metal electrodes (R) 412-2 and 412-3.

If the user's finger 510 approaches the touch pad 400, or directly contacts the touch pad 400, current change occurs at the metal electrodes 412-1 to 412-4. The current detection units 440-1 to 440-4 measure the current change, and the position detection unit 480 calculates the horizontal coordinates of the finger 510 located on the touch pad 400 using the current change, as described above, and then provides the information to the controller 180. Thus, the controller 180 recognizes the horizontal coordinates on the touch screen 500 contacted by the finger 510, performs a user instruction corresponding to the touch motion, and also provides a desired GUI on the display module 151.

In FIG. 5 and FIG. 6, the touch time measurement unit 460, the distance detection unit 470, and the position detection unit 480 are separately illustrated, but may be part of the controller 180.

Referring to FIG. 4, FIG. 5, and FIG. 6, determining whether the input medium performs the proximity touch motion or the direct touch motion with respect to the touch screen 500 is described using the touch screen 500 having the capacitive sensing type touch pad 400. However, according to an embodiment of the present invention, alternative configurations of the touch pad 400 and metal electrodes 412-1 to 412-4 may be utilized to determine whether the input medium performs the proximity touch motion or the direct touch motion.

For example, the touch pad 400 can be realized to detect the proximity position between the input medium and the touch pad 400 by using an optical sensor having a laser diode and a light emitting diode, a high frequency oscillation proximity sensor, and a magnetic proximity sensor. Alternatively, the touch pad 400 can be realized by forming a metal electrode on an upper or lower plate and combining a capacitive sensing type touch pad and a resistive sensing type touch pad which detects change of voltage according to a pressed position of an input medium.

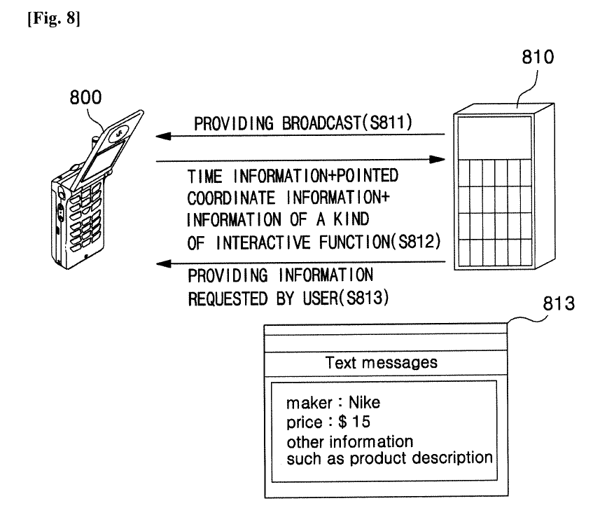

FIG. 7 is a block diagram illustrating a mobile terminal according to an embodiment of the present invention. Referring to FIG. 7, a mobile terminal 700 includes an input display unit 710, a controller 720, a communication unit 730, and a memory 740.

The input display unit 710 is disposed at a front face of the mobile terminal 700 so as to receive a user instruction and provide information requested by the user. The input display unit 710 includes a pointing device so that a user can input the user instruction by pointing to a desired object. A touch screen as an example of the pointing device generally used in the mobile terminal, and the input display unit 710 includes the pointing device. When a user wants to receive information on a particular object while seeing a broadcast, the user can clearly specify the object by pointing to the object. In order to reduce power consumption in the mobile terminal 700, the input display unit 710 activates the pointing device only when receiving a user instruction. The method of activating the pointing device includes a pointing method of an unspecific portion of an entire surface of the pointing device and a pointing method of an activation icon displayed at the input display unit. In other words, the user can activate the deactivated input display unit 710 through the activation icon and then point to a desired object. In order to reduce the power consumption in the mobile terminal 700 and prevent an undesired function from being performed by erroneous pointing, the input display unit 710 can be deactivated again.

If a user instruction is inputted to the mobile terminal 700, the controller 720 requests information corresponding to the user instruction from an external provider server (e.g., base station/network) and then provides the information to the user. In order to clearly specify a desired object, the controller 720 receives coordinate information on a position on the input display unit 710 designated by the user. In order to specify a scope of the object contained in a broadcast image when the user performs a pointing operation, the interactive function selected by the user is stored. The controller 720 transmits to an external provider server the pointed coordinate information, the information on the selected interactive function, and the time information when the user performs the pointing operation thereby requesting information on the specified object. The time information corresponds to a time stamp recognized by the external provider server. If the broadcast is received in real-time, the time information is the time when the user performs the pointing operation, and if the broadcast is a recorded broadcast, the time information is the reproduction time from a point of time when the first broadcast is started to a point of time when the user performs the pointing operation. The controller 720 can receive the requested information in the form of a character message from the external provider server. The character message is in the form of an SMS message, an MMS message, and an e-mail including text, an image, an icon, a moving image, and/or an animation.

The user has to specify and select one of a plurality of objects contained in a broadcast image, and the interactive function can be used to receive the user instruction. The interactive function is provided in an interactive broadcasting service. For example, if an external provider inserts a popularity voting function for actors or actresses appearing in a movie, the user can use the interactive function by selecting and inputting his/her favorite actor or actress through the mobile terminal while seeing the movie through the mobile terminal. Furthermore, if the external provider inserts information on particular goods appearing in a broadcast program, the user can additionally receive the information on the particular goods by selecting the interactive function.

The information on the kinds of interactive functions is previously stored in the mobile terminal 700, and the kinds of interactive functions can include a person, goods, background information, and anything else that appears in the broadcast image and which can be specified by a user instruction. The user can receive detailed information on the kinds of interactive functions available by pointing to a function icon displayed on the input display unit 710 of the mobile terminal 700. The detailed information on the kinds of interactive functions can be displayed on the input display unit 710 while the broadcast is stopped by the user instruction. Alternatively, the detailed information on the kinds of interactive functions can be semitransparently displayed on the input display unit 710 while the broadcast is continuously reproduced.

The communication unit 730 provides a communication channel so that the mobile terminal 700 can communicate with the external provider server. The mobile terminal 700 transmits to the external provider server through the communication unit 730 the time information when the user performs the pointing operation, the coordinate information on the position designated by the user, and the information on the interactive function selected by the user as information by which the user can specify the desired object. The external provider server transmits information requested by the user to the mobile terminal 700 through the communication unit 730. The information transmitted from the external provider server to the mobile terminal 700 may be in the form of a character message. The character message is in the form of an SMS or MMS message including text, an image, an icon, a moving image, and/or an animation. Communication between the mobile terminal 700 and the external provider server may use a personal communication service according to a W-CDMA system based on global system for mobile (GSM) communication. The communication unit 730 includes a broadcasting receiver and a wireless transmitter/receiver. The broadcasting receiver decodes and outputs a broadcast signal received from the external provider server, and the wireless transmitter/receiver transmits and receives signals to/from the external provider server through the mobile communication network.

The memory 740 stores information for driving various functions provided in the mobile terminal 700. The memory 740 previously stores the kinds of interactive functions and provides the information to the controller 730 so that the kinds of interactive functions may be displayed on the input display unit 710 when a user wants to select the interactive function. The kinds of interactive functions may include people, goods, background information, and other objects appearing in the broadcast image and which can be specified by a user instruction.

Hereinafter, the construction of the mobile terminal 700 shown in FIG. 7 will be compared with that in FIG. 1. The input display unit 710 is a device that functions to input information for controlling an operation of the mobile terminal 700 and output information processed in the mobile terminal 700. Therefore, the input display unit 710 may correspond to a combination of the manipulation unit 130 and the output unit 150 of the mobile terminal 100 of FIG. 1.

The controller 720 is a device that typically controls an entire operation of the mobile terminal 700. The controller 720 may correspond to the controller 180 of the mobile terminal 100 of FIG. 1.

The communication unit 730 is a device that transmits and receives a signal in the mobile terminal 700. The communication unit 730 may correspond to the wireless communication unit 110 of the mobile terminal 100 of FIG. 1.

The memory 740 is a device that stores various information that drive the functions provided in the mobile terminal 700. The memory 740 may correspond to the memory 160 of the mobile terminal 100 of FIG. 1.

Hereinafter, a method of providing information using the mobile terminal 700 according to an embodiment of the present invention will be described. An information providing method including the interactive function according to one embodiment of the present invention is as follows.

In order to receive detailed information on the kinds of interactive functions available, a user points to and selects a function icon displayed on the input display unit 710. Once the function icon is selected, the detailed information on the kinds of interactive functions that are previously stored in the memory 740 of the mobile terminal 700 is displayed on the input display unit 710. The detailed information on the kinds of interactive functions can generally include goods information, personal information, and background information. Once an interactive function is selected, the user can select desired information and input a user instruction. If the user inputs the user instruction by pointing to the desired object, the controller 720 receives information on a position pointed to by the user in the form of coordinate information. In order to specify information designated by the user and then request the information to the external provider server, the controller 720 transmits information on broadcasting time, coordinate information on the position pointed to by the user, and information on the selected interactive function. The external provider server retrieves information requested by the user using the information transmitted from the mobile terminal 700, and then transmits the retrieved information in the form of a character message. By these processes, the user can receive the desired information from the external provider server through the mobile terminal 700.

The information providing method by activating the pointing device according to another embodiment of the present invention is as follows. If a user points a desired object on the activated input display unit 710 to input a user instruction by a pointing operation of the user, detailed information on the kinds of interactive functions that are previously stored in the memory 740 of the mobile terminal 700 is displayed on the input display unit 710. The detailed information on the kinds of interactive functions can generally include goods information, personal information, and background information. The user can select the desired information from the available interactive functions and can input the user instruction. The controller 720 receives information on a position pointed by the user in the form of the coordinate information. In order to specify information designated by the user and then request the information to the external provider server, the controller 720 transmits information on broadcasting time, coordinate information on the position pointed to by the user, and information on the interactive function selected. The external provider server retrieves information requested by the user using the information transmitted from the mobile terminal 700, and then transmits the retrieved information in the form of a character message. By these processes, the user can receive the desired information from the external provider server through the mobile terminal 700.

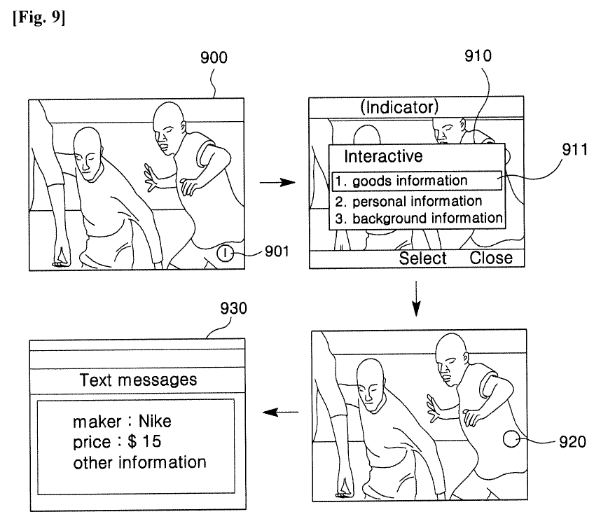

FIG. 8 is a schematic view illustrating a transmitting and receiving process between the mobile terminal and an external provider server. In order to provide desired information to a user, information is transmitted and received between the mobile terminal 800 and the external provider server 810. The external provider server 810 provides to the mobile terminal 800 various digital broadcasts that the user can watch (S811).

While the user watches a broadcast through the mobile terminal 800, if there is an object on which the user wants to receive information, the user specifies the object and inputs a user instruction. The mobile terminal 800 transmits to the external provider server 810 information specifying the user instruction. Pointed coordinate information, time information when a user performs a pointing operation, and information on the interactive function selected by the user can be transmitted as the information specifying the user instruction (S812).

The external provider server 810 receives the detailed information corresponding to the user instruction from the mobile terminal 800, and then transmits information requested by the user. The information requested by the user can be transmitted in the form of a character message to the mobile terminal 800 (S813). For example, the information requested by the user may include the manufacturer of the product, the price of the product, and other information on the product such as a product description.

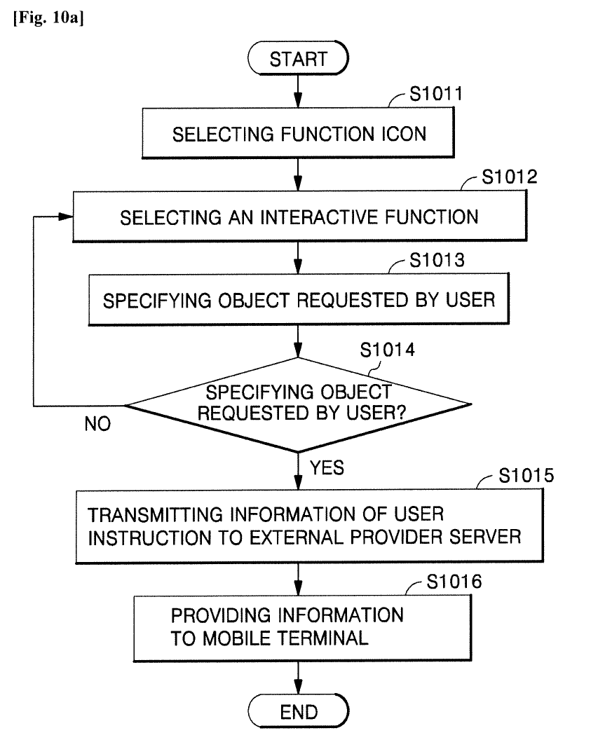

FIG. 9 is a schematic view illustrating a display state of a display unit through which the user inputs a user instruction by selecting an interactive function and receives the information. A user can receive detailed information 910 on the interactive functions available by pointing to a function icon 901 displayed on the input display unit of the mobile terminal 900. The user can receive desired information by selecting an interactive function and pointing to a desired object (920).

The function icon 901 serves to inform a point of time when the user wants to obtain information while watching a broadcast, and also to display detailed information on the kinds of interactive functions available.

The detailed information 910 on the kinds of interactive functions is categorized according to objects to which the user can point and select, and may include goods information, personal information, and background information that can be contained in a broadcast image. The detailed information 910 of the kinds of interactive functions can be displayed while the broadcast is stopped, or can be semitransparently displayed while the broadcast is continuously reproduced.

For example, when a user wants to obtain information on a uniform of a soccer player while the user watches a soccer game through the mobile terminal 900, the user selects the function icon 901 displayed on the input display unit and receives the detailed information 910 of the kinds of interactive functions available. Since the user now wants to obtain information on the uniform of the soccer player, the user can select an interactive function by pointing to goods information is the list containing “1. goods information,” “2. personal information,” and “3. background information.” The user can then input a user instruction by pointing to the uniform 920 as the desired object. The user will subsequently receive the information on the uniform in the character message 930 transmitted from the external provider server.

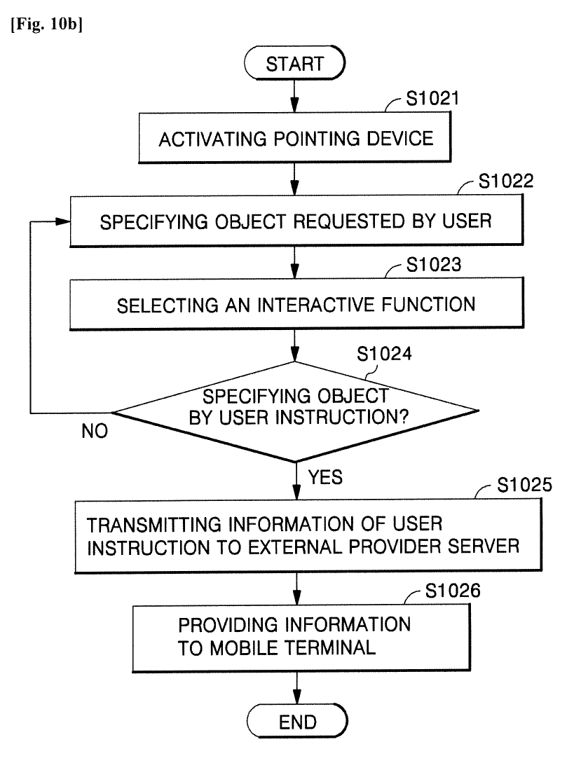

FIG. 10 is a schematic view illustrating information providing processes using the mobile terminal according to one embodiment of the present invention. FIG. 10a is a flow chart illustrating a process of providing desired information by selecting an interactive function and inputting a user instruction according to one embodiment of the present invention. FIG. 10b is a flow chart illustrating a process of providing desired information by activating a pointing device and inputting a user instruction according to another embodiment of the present invention.

Referring to FIG. 10a, if a user points to and selects a function icon, the mobile terminal displays detailed information on the kinds of interactive functions available on an input display unit (S1011). The user specifies a user instruction by selecting one of the interactive functions in the list (S1012). The user inputs the user instruction by specifying and pointing to an object contained in a broadcast image on which the user wants to obtain information (S1013). If the object designated by the user is specified through these processes (S1014), the mobile terminal transmits to the external provider server time information when the user performed a pointing operation, coordinate information on a position designated by the user, and information on the interactive function selected by the user (S1015). The external provider server receives the information from the mobile terminal and retrieves information requested by the user and then transmits the retrieved information in the form of a character message to the mobile terminal (S1016).

Referring to FIG. 10b, if a user points to an activation icon, a pointing device in the input display unit is activated (S1021). The user inputs a user instruction by specifying and pointing to an object contained in a broadcast image on which the user wants to obtain information (S1022). If the user performs a pointing operation, the mobile terminal displays detailed information on the kinds of interactive functions available that correspond to a position pointed to by the user (S1023). If the object designated by the user is specified through these processes (S1024), the mobile terminal transmits to the external provider server time information when the user performed the pointing operation, coordinate information on a position pointed to by the user, and information on the interactive function selected by the user (S1025). The external provider server receives the information from the mobile terminal and retrieves the information requested by the user and then transmits the retrieved information in the form of a character message to the mobile terminal (S1026).

In an alternative embodiment, the pointing operation of the user as described above is outputted in the form of a vibration pattern. In such an embodiment, the entire or a part of the embodiments may be combined so as to change or to modify the implementations consistent with the alternative embodiment.

While the invention has been described in terms of exemplary embodiments, it is to be understood that the words which have been used are words of description and not of limitation. As is understood by persons of ordinary skill in the art, a variety of modifications can be made without departing from the scope of the invention defined by the following claims, which should be given their fullest, fair scope.

What is claimed is:

1. A wireless communication terminal for use in an interactive communication with a base station to allow exchange of displayed image related information, comprising:
a display configured to display a broadcast image from the base station, the broadcast image being associated with a time stamp recognized by the base station, the broadcast image comprising an object displayed on the display;
an input module configured to recognize a selected position on the display associated with the object; and
a controller in communication with the display and the input module, the controller being configured to associate the selected position with the object, to provide coordinate data corresponding to the selected position, to provide to the base station a time reference in relation to the time stamp when the selected position is recognized, to receive from the base station object information related to the object, and to display the object information received from the base station.

2. The wireless communication terminal of claim 1, wherein the input module comprises a touch screen for sensing a user touch and for recognizing the selected position.

3. The wireless communication terminal of claim 1, wherein the object information comprises at least one of price, manufacturer, or production description.

4. The wireless communication terminal of claim 1, wherein the controller is configured to receive the object information through one of a text message, a multimedia message, or an electronic e-mail.

5. The wireless communication terminal of claim 1, wherein the controller is configured to provide an activation icon on the display for allowing or disallowing a user to select the selected position on the display associated with the object.

6. The wireless communication terminal of claim 1, wherein the controller receives the object information in the form of a character message from the network.

7. The wireless communication terminal of claim 6, wherein the character message is a short-message-service message or a multimedia-messaging-service message.

8. The wireless communication terminal of claim 1, further comprising a memory for storing available interactive functions.

9. The wireless communication terminal of claim 8, wherein the controller is configured to display a function icon on the display for allowing a user to request display of the available interactive functions.

10. A method of interactive communication in a wireless communication terminal for allowing a user to select an object displayed in a broadcast image and to obtain information on the displayed object, the method comprising:
displaying a broadcast image from the base station, the broadcast image being associated with a time stamp recognized by the base station, the broadcast image comprising an object displayed on the display;
recognizing a selected position on the display associated with the object; and
associating the selected position with the object;
providing coordinate data corresponding to the selected position and a time reference in relation to the time stamp when the selected position is recognized;
receiving object information related to the object; and
displaying the received object information.

11. A wireless communication terminal for use in an interactive communication with a base station to allow exchange of displayed image related information, comprising:
an input display unit configured to receive pointing inputs from a user during a broadcast, the pointing inputs including a user instruction pointing input corresponding to a user instruction;
a communication unit configured to form a communication channel with a network; and
a controller configured to transmit time information on when the user provides the user instruction pointing input, to transmit coordinate information on a position of the user instruction pointing input to the network, to receive information on an object corresponding to the user instruction pointing input from the network, and to provide the information to the user.

12. The wireless communication terminal of claim 11, wherein the controller is configured to receive coordinate information from the input display unit, the coordinate information being positions on the input display unit corresponding to the pointing inputs.

13. The wireless communication terminal of claim 11, wherein the controller is configured to provide an activation icon on the input display unit for allowing or disallowing the user instruction pointing input.

14. The wireless communication terminal of claim 13, wherein the controller is configured to allow the user instruction pointing input when the user provides a pointing input to the activation icon displayed on the input display unit while the user instruction pointing input is disallowed, and is configured to disallow the user instruction pointing input when the user provides a pointing input to the activation icon displayed on the input display unit while the user instruction pointing input is allowed.

15. The wireless communication terminal of claim 11, wherein the controller receives the information in the form of a character message from the network.

16. The wireless communication terminal of claim 15, wherein the character message is a short-message-service message or a multimedia-messaging-service message.

17. The wireless communication terminal of claim 11, wherein the controller receives from the network information having at least one of the forms of a text, an image, an icon, a moving image, or an animation and then displays the information on the input display unit.

18. The wireless communication terminal of claim 11, wherein the information on the object is at least one of personal information, goods information, or background information contained in a broadcast.

19. The wireless communication terminal of claim 11, further comprising a memory for storing available interactive functions.

20. The wireless communication terminal of claim 19, wherein the controller is configured to transmit to the network a reproduction time and information on a user-selected interactive function of the available interactive functions, the reproduction time being a time period from a start of the broadcast to a time at which the user provides the user instruction pointing input.

21. The wireless communication terminal of claim 19, wherein the controller is configured to display a function icon on the input display unit for allowing a user to request display of the available interactive functions.

22. The wireless communication terminal of claim 21, wherein the controller is configured to display detailed information on the available interactive functions when the user provides a pointing input on the function icon displayed on the input display unit.

23. The wireless communication terminal of claim 19, wherein the controller is configured to display detailed information on the available interactive functions when the user provides the user instruction pointing input.

24. The wireless communication terminal of claim 19, wherein the controller is configured to display the received information on the object while the broadcast is stopped.

25. The wireless communication terminal of claim 19, wherein the controller is configured to display semitransparently the received information on the object while the broadcast is playing.
